(19) United States
(12) Patent Application Publication
(10) Pub. No.: US 2012/0298238 A1
(43) Pub. Date: Nov. 29, 2012

(54) MODULAR FLUIDIC MIXING SYSTEM

(75) Inventors: William M. Cost, Hartselle, AL (US); FRANK A. RUIZ, Greenwell Springs, LA (US)

(73) Assignee: Parker-Hannifin Corporation, Cleveland, OH (US)

(21) Appl. No.: 13/467,211

(22) Filed: May 9, 2012

Related U.S. Application Data
(60) Provisional application No. 61/489,715, filed on May 25, 2011.

(51) Int. Cl. G05D 11/035

(52) U.S. Cl. 137/897; 137/606

(57) ABSTRACT

Modular fluidic mixing system for delivering a fluid mixture from separate sources to a point of use. The system includes a mounting board and a series of rows of substrate fittings mounted on the board. Each row has a first end fitting connected to one of the fluid sources and a second end fitting. Each of the fittings in a row is connected in fluid communication to an adjacent one of the fittings in the row to define a fluid flow path from the one of the fluid sources to the second end fitting. Each second end fitting in each row is connected in fluid communication to an adjacent second end fitting in an adjacent row to define a mixing header. The fluids are mixed within the header and exit as a mixture. Fluid flow components for controlling flow from the fluid sources are mounted to the fittings.

### CROSS REFERENCE TO RELATED APPLICATIONS

The present application claims the benefit of the filing date of U.S. Provisional Application Ser. No. 61/489,715 filed May 25, 2011, the disclosure of which is incorporated herein by reference.

### BACKGROUND OF THE INVENTION

The present invention relates broadly to fluidic mixing systems such as for the mixing and dilution of liquids and gases used for calibrating spectrometers, chromatographs, and other analytical equipment, or in industrial processes.

Conventional calibration methods typically involve the use of individual tanks of one or more purchased gas or liquid mixtures which are used as standards or samples to complete the calibration of the analytical systems. These methods, however, do not allow for the concentration of the mixture in the tank to be changed. Rather, the purchase of separate tanks of the sample or standard which are pre-mixed at the desired concentrations usually is required. Such purchase constitutes an additional expense which most users of the equipment would wish to avoid.

As shown, for example, in U.S. Pat. Nos. 6,772,781; 5,950,675; 5,239,856; 5,157,957; and 3,830,256, systems have been proposed for mixing gases and other fluids on-site. Such systems, however, generally employ welded or threaded connections of the component parts. It is believed that improvements in these types of systems would be well-received by chemical manufacturers and processors, as well as operators of oil and gas refineries, laboratories, and others.

### BROAD STATEMENT OF THE INVENTION

The present invention is directed to a fluidic mixing system for mixing two or more individual fluid flow streams each fed from a separate tank, cylinder, or other fluid source. Such system may be used, for example, for the dilution of liquids and gases in the on-site production of industrial process mixtures, such as for chemical, petrochemical, or semiconductor processes, or of standard mixtures such as employed in obtaining calibration curves or otherwise in the calibration of analytical equipment such as spectrometers, chromatographs, and other instruments.

In accordance with the precepts of the present invention, substrate fittings, such as in the form of blocks, are arranged in a series of rows on a pegboard or other mounting board. Fluid flow components, such as valves, regulators, flow controllers, and the like are each mounted on top of a corresponding one of the fittings. The fittings in each row of the series are interconnected via internal passageways and a fluid connector interposed between each adjacent fitting to define a separate fluid flow path, i.e., circuit, for each of the fluid flow streams. Each of the separate fluid flow circuits lead from the flow source to a common mixing header wherein the streams are mixed to yield a fluid mixture having the desired composition and concentration. The fluid mixture then is delivered from the header to the analytic instrument or other point of use. Advantageously, the modular mounting hardware employed in the system may be ANSI (American National Standards Institute)/ISA (Instrumentation, Systems, and Automation Society) Specification (SP) 76.00.02 compliant. Such hardware also reduces the number of component fluid connections required and the attendant risk of leakage at each connection.

The present invention, accordingly, comprises the design, fabrication, construction, combination of elements, and/or arrangement of parts and steps, which are exemplified in the detailed disclosure to follow. Advantages of the present invention include a high-precision fluidic mixing system platform for mixing two or more individual fluid flow streams fed from separate sources. Such platform is modularly configurable to support a variety of process and analytical applications, and is amenable to either manual or electronic control. Such platform further, by virtue of allowing for the inclusion of volumetric or mass flow control, enables the operator to accommodate a wide range flows, concentrations, and mixing ranges in producing standard gas and other fluid mixtures on-site and at the point of use concentration without changing hardware or purchase of additional standards. Additional advantages include a modular platform which is ANSI/ISA SP76.00.02 compliant, is readily transitionable between manual and electronic control, and otherwise provides an efficient and cost-effective approach for reducing standard gas costs. These and other advantages will be readily apparent to those skilled in the art based upon the disclosure contained herein.

### BRIEF DESCRIPTION OF THE DRAWINGS

For a fuller understanding of the nature and objects of the invention, reference should be had to the following detailed description taken in connection with the accompanying drawings wherein:

FIG. 1 is a schematic diagram of a modular fluidic mixing system in accordance with the present invention;

FIG. 2 is a top view of a representative modular fluid component subassembly for the system of FIG. 1;

FIG. 3 is a cross-sectional view of the subassembly of FIG. 2 taken through line 3-3 of FIG. 2;

FIG. 4A is a top view of an “elbow” substrate fitting configuration for the header of the mixing system of FIG. 1; and

FIG. 4B is a top view of a “straight” substrate fitting configuration for the header of the mixing system of FIG. 1.

The drawings will be described further in connection with the following

### DETAILED DESCRIPTION OF THE INVENTION

Certain terminology may be employed in the following description for convenience rather than for any limiting purpose. For example, the terms “forward” and “rearward,” “front” and “rear,” “right” and “left,” “upper” and “lower,” and “top” and “bottom” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “horizontal” and “axial” or “vertical” referring, respectively, to directions or planes which are perpendicular, in the case of radial or horizontal, or parallel, in the case of axial or vertical, to the longitudinal central axis of the referenced element, and the terms “downstream” and “upstream” referring, respectively, to directions in and opposite that of fluid flow. Terminology of similar import other than the words specifically mentioned above likewise is to be considered as being used for purposes of convenience rather than in any limiting sense. In certain views of the figures, the axial direction may be shown by an arrow labeled “A,” and the radial direction may be shown by an arrow labeled “R.”

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows.

For the illustrative purposes of the discourse to follow, the fluidic mixing system herein involved is described in connection with its configuration use for the dilution of liquids and gases in the on-site production of industrial process mixtures, such as for chemical, petrochemical, or semiconductor processes, or of standard mixtures such as employed in obtaining calibration curves or otherwise in the calibration of analytical equipment such as spectrometers, chromatographs, and other instruments. It will be appreciated, however, that aspects of the present invention may find utility in other fluid mixing applications. Such applications and configuration of the system for such applications should be considered to be expressly within the scope of the present invention.

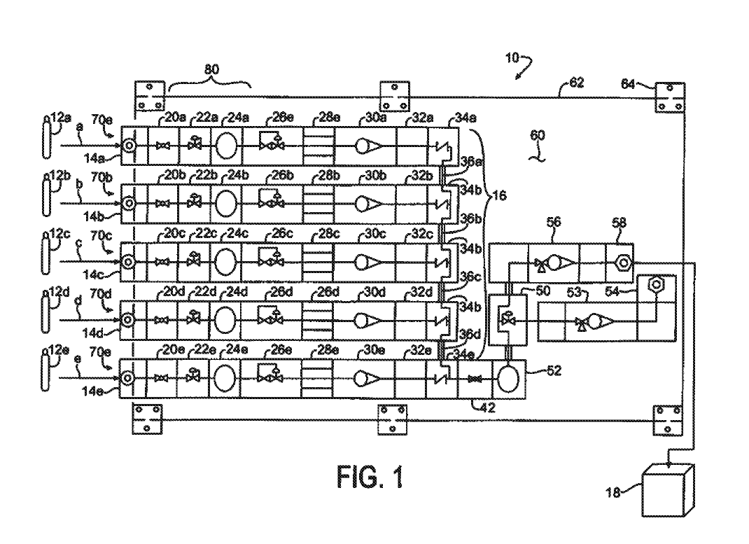

Referring then to the figures wherein corresponding reference characters are used to designate corresponding elements throughout the several views with equivalent elements being referenced with prime or sequential alphanumeric designations, a representative modular fluidic system configuration for mixing and diluting or otherwise delivering multiple streams of gases or other fluids is referenced generally at 10 in FIG. 1. In basic operation, multiple streams of gases, designated a-e, from separate cylinders or other sources, 12a-e, are introduced into the system 10 via a respective inlet port, 14a-e, for delivery from a mixing header, referenced at 16, to a point of use, 18, such as an analytical instrument or a unit operation of a chemical or other process.

In the illustrated embodiment of system 10, each of the respective gas streams a-e flows in succession from left to right through an isolation valve, 20a-e, to a pressure reducing regulator, 22a-e, which may have an associated pressure gauge, 24a-e. Each pressure regulator 22a-e may be set to run at the pressure required at the point of use 18, and is connected to a flow controller, 26a-e, which may be mass or volumetric controller, and which may have an associated a rotameter or other flowmeter or flow rate gauge, 28a-e.

From each controller 26a-e, each of the streams a-e may be delivered at a regulated pressure and flow rate into header 16 through a check valve, 30a-e, and a corresponding inlet block or other connection, 32a-e, of the header 16. Header 16 itself may be comprised of individual blocks, 34a-e, joined in fluid communication via a series of connections, 36a-d. Together the blocks 34 and 36 define a common plenum on the board 62 within which the individual gas streams are mixed. As so mixed, the streams a-e exit from the header 16 as a gas standard or sample mixture through an outlet which may be controlled by an isolation valve, 42.

From valve 42, the mixture flows to a back pressure regulator, 50, which may have an associated pressure gauge, 52. The back pressure regulator 50, which may be vented via a flowmeter, 53, and a vent outlet port, 54, mitigates pressure fluctuations and otherwise stabilizes the pressure of the gas streams a-e at the outlets of the flow controllers 26 for a more consistent and efficient mixing environment within the header 16. From regulator 50, the mixed gas streams are delivered as a gas mixture through a flowmeter, 56, and a sample outlet port, 58, to the point of use 18. In this regard, back pressure regulator 50 also stabilizes and may be used to control the pressure of the mixed gas streams a-e as delivered to the inlet of the point of use 18.

System 10 advantageously may be configured on a modular platform such as the type shown in commonly-assigned U.S. Pat. No. 7,178,556. As shown in Parker Intraflow™ ISA/ANSI SP76.00.02 Compliant Modular Systems Catalog 4250, December 2003, such platforms are marketed commercially by the Instrumentation Products Division of Parker Hannifin Corporation, Huntsville, Ala. In this regard, the componentry comprising system 10 may be mounted on an upper surface, 60, of a pegboard-type platform or other board, 62, which may be formed of an aluminum, stainless steel, or other metal, or a chemically-resistant plastic or other material, having an array of holes (not shown in FIG. 1), and which may have one or more brackets, one of which is referenced at 64, for the mounting of board 62 to a stand, table, or other fixture.

As further described in U.S. Pat. No. 7,178,556, substrate fittings, which may be configured generally in the shape of blocks having top and bottom faces separated by side faces, and which also may be formed of an aluminum, stainless steel, or other metal, or a chemically-resistant plastic or other material, may be mounted to the board upper surface 60 using screws, bolts, or other fasteners received through holes provided through the fittings and threaded into a corresponding hole in the board. Each of the fittings may be connected to each adjacent fitting via a generally tubular pressure connector interposed therebetween. Each fluid connector has a first end which may be received within a corresponding connector port formed into a side face of the fitting and a second end which may be received within a corresponding connector port of an opposing side face of an adjacent fitting. The connector ports on opposite side faces of the each of the fittings each may be connected via an internal passageway to a corresponding component port which opens into the fitting top face.

Fluid components, such as valves, flow controllers, pressure regulators, gauges, couplers, and the like may be mounted in fluid communication with the component ports on the top face of a corresponding one of the fittings. In this regard, the fluid components may be formed as having a flange through which holes are provided for registration with corresponding holes formed through the fitting. Screws, bolts, or other fasteners may be received through the holes provided in the component and screwed into the matching holes in the fitting to mount the components to the fittings.

As may be seen with continuing reference to FIG. 1, the substrate fittings and fluid components comprising the fluid flow path for the delivery of each of the gas streams a-e from each of the sources 12a-e to the corresponding inlet 32a-e of header 16 may be arranged in a series of rows, referenced generally at 70a-e, mounted on board 62. Each row thus includes, for example, a corresponding inlet port 14a-e mounted to an associated substrate fitting at a first end of the corresponding one of the rows 70a-e, and, for example, a corresponding check valve 30a-e at a second end of the row.

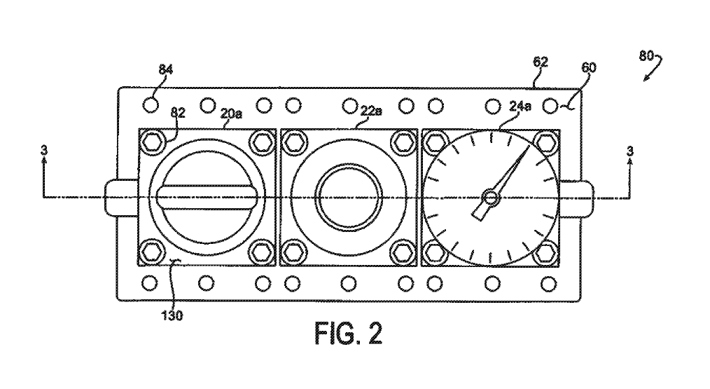

Turning next to FIG. 2 a top view shows in enhanced detail the arrangement of a subassembly, 80, of system 10, such subassembly including valve 20a, regulator 22a, and pressure gauge 24a on board 62. As may be seen, screws, bolts, or other fasteners, one of which is referenced at 82, are employed to bolt the fluid components 20a, 22a, and 24a, along with the underlying substrate fittings (not shown in FIG. 2), onto board 62 using the matching holes from the array thereof, one of such holes being referenced at 84.

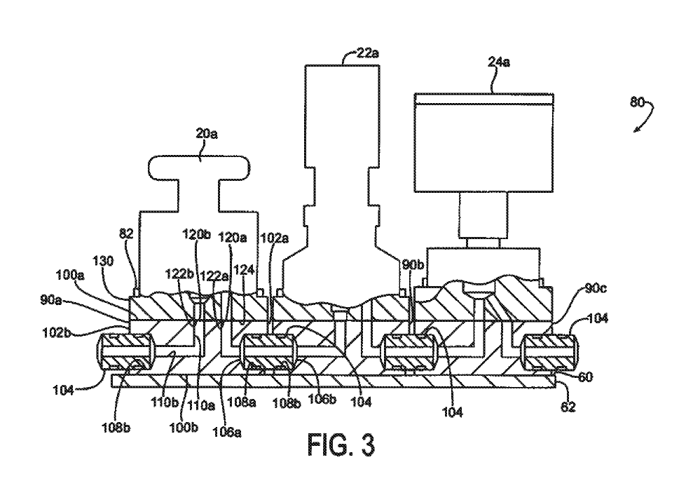

With reference now to FIG. 3 wherein subassembly 80 is shown in cross-section, it may be seen that each of the fluid components 20a, 22a, and 24a, and each of the associated substrate fittings, 90a-c, respectively, are mounted on upper surface 60 of board 62. As mentioned, each of the fittings 90a-c are configured as a having, respectively, top and bottom faces referenced for fitting 90a at 100a-b, and side faces, two of which are commonly referenced for fitting at 102a-b. Each of the fittings 90a-c further are shown to be connected to each adjacent fitting via a generally tubular, press-fit or other pressure connector, commonly referenced at 104, interposed therebetween.

As illustrated for the connector 104 interposed between fittings 90a and 90b, such connector 104 has a first end, 106a, which is received within a corresponding connector port, 108a, formed into side face 102a of fitting 90a, and a second end, 106b, which is received within the opposing connector port 108b of side face 102b of fitting 90b. As further illustrated for fitting 90a, the connector ports 108a-b on each of the opposite side faces 102a-b may be connected via a corresponding internal passageway, 110a-b, to a corresponding component port, 120a-b, which opens into the fitting top face 100a. Each component port 120a-b then connects in fluid communication with a corresponding port in an opposing surface of the component, such as ports 122a-b of component 20a which open into face 124 thereof.

In the assembling of subassembly 80, substrate fittings 90a-c may be mounted to surface 60 of board 62 using screws (not shown) which each may be received through a hole (not shown) through the fitting and into a matching one of the holes 84 in board 62. With fittings 90a-c being so mounted to board 62, each of the fluid components 20a, 22a, and 24a then may be mounted to a corresponding one of the fittings. In this regard, and as illustrated for component 20a, the component may be provided with a flange portion, 130, through which holes may be provided (not shown) for receiving screws 82 and registration with matching holes (not shown) in fitting 90a.

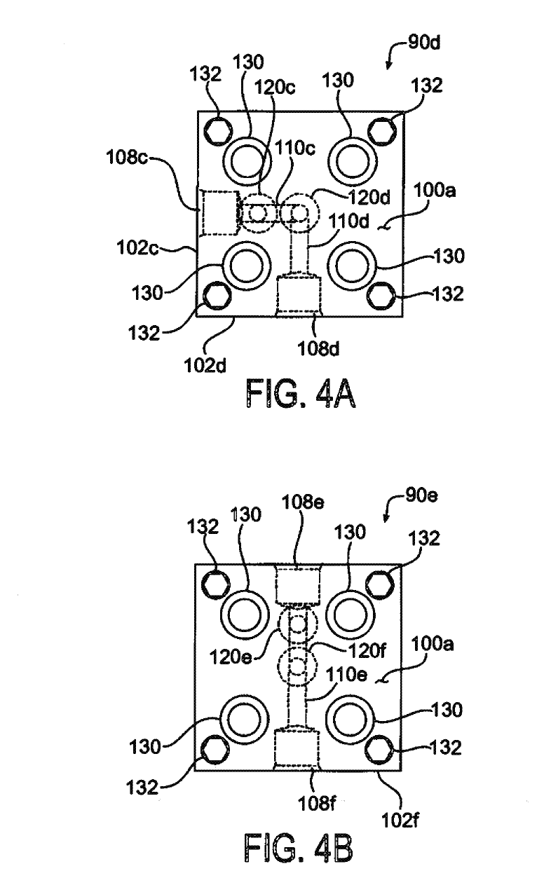

As to header 16 (FIG. 1), blocks 34a-e and connections 36a-d may be provided as an arrangement of the aforementioned substrate fittings 90 and associated connectors 104. End blocks 34a and 34e may be provided as shown at 90d in FIG. 4A as an “elbow” configuration with ports 108c and 108d opening into adjacent side faces 102c and 102d, with the remaining blocks 34b-34d being provided as shown at 90e in FIG. 4B as a “straight” configuration with ports 108e and 108f opening into opposite side faces 102e and 102f. Ports 108c-d and 108e-f may be connected directly within the fitting 90d and 90e via, respectively the passageways 110c-d and 110e as shown. Alternatively, ports 120c-d shown in phantom in FIG. 4A and ports 120e-f shown in phantom in FIG. 4B may be provided as opening into face 100a for the connection of a fluid component such as a shut-off, check of other valve as represented in FIG. 1 for blocks 34a-e. One of the ports 108c or 108d in the fitting 90d corresponding, for example, to block 34e (FIG. 1) may be used as the outlet of header 16 to which valve 42 is connected. The holes for mounting the fittings 90 to the board 62 are commonly referenced in FIGS. 4A-B at 130, with the holes for screws 82 (FIG. 3) for the mounting of a component to the fitting 90 being commonly referenced 132. As arranged on board 62 as depicted in FIG. 1, each of the connections 36a-d between the fittings 90 corresponding to the blocks 34a-e may be provided as a connector 104 (FIG. 3).

Thus, a modular fluidic system incorporating the construction of present invention has been described.

As it is anticipated that certain changes may be made in the present invention without departing from the precepts herein involved, it is intended that all matter contained in the foregoing description shall be interpreted as illustrative and not in a limiting sense. All references including any priority documents cited herein are expressly incorporated by reference.

What is claimed is:

1. A modular fluidic mixing system for delivering a mixture of fluids under pressure from two or more fluid sources to a point of use, the system comprising:
a mounting board;
a series of rows of substrate fittings mounted on the board, each row having a first end fitting connected in fluid communication to one of the fluid sources and a second end fitting, each of the fittings in a row being connected in fluid communication to an adjacent one of the fittings in the row to define a fluid flow path from the one of the fluid sources to the second end fitting, and each second end fitting in each row being connected in fluid communication to an adjacent second end fitting in an adjacent row to define a mixing header, one second end fitting having an outlet defining the header outlet, the fluids being mixed under pressure within the header and exiting the header as a mixture from the header outlet; and
one or more fluid flow components for controlling the flow fluid from each of the fluid sources, each of the fluid flow components being mounted in fluid communication to a corresponding one of the fittings in each of the rows.

2. The system of claim 1 wherein the fluid flow components comprise a pressure regulator and a flow controller.

3. The system of any of the preceding claims further comprising a back pressure regulator mounted on the board, the back pressure regulator having an inlet connected in fluid communication to the outlet of the header and an outlet connected in fluid communication to the point of use.

4. The system of any of the preceding claims wherein each of the substrate fittings has one or more internal passageways therethrough, each of the fluid flow components being mounted in fluid communication to the corresponding one of the fittings via one or more of the passageways.

5. The system of any of the preceding claims further comprising a fluid connector interposed between each of the fittings and each adjacent fitting in each of the rows, each fluid connector interconnecting one of the passageways in each of the fittings in fluid communication with a corresponding one of the passageways in each adjacent fitting.

6. The system of any of the preceding claims further comprising a fluid connector interposed between each second end fitting and each adjacent second end fitting in each adjacent row, each fluid connector interconnecting one of the passageways in each second end fitting in fluid communication with a corresponding one of the passageways in each adjacent second end fitting.
